(19) United States
(12) Patent Application Publication
(10) Pub. No.: US 2021/0073009 A1
(43) Pub. Date: Mar. 11, 2021

(54) System and Method for Generating Customized Knowledge Capture Websites with Embedded Knowledge Management Functionality Using Word Processor Authoring Tools

(71) Applicants: Shruti Ahuja-Cogny, Brooklyn, NY (US); Adrien Cogny, Brooklyn, NY (US)

(72) Inventors: Shruti Ahuja-Cogny, Brooklyn, NY (US); Adrien Cogny, Brooklyn, NY (US)

(21) Appl. No.: 17/017,146

(22) Filed: Sep. 10, 2020

Related U.S. Application Data
(60) Provisional application No. 62/898,222, filed on Sep. 10, 2019.

(51) Int. Cl. G06F 9/451; G10L 15/26; G06N 20/00; G06F 40/35; G06F 40/174

(52) U.S. Cl. CPC G06F 9/451; G10L 15/26; G06Q 10/1053; G06F 40/35; G06F 40/174; G06N 20/00

(57) ABSTRACT

Systems and methods for generating a customized knowledge capture website are provided. The system includes a memory and a processor in communication with the memory. The processor transmits a web authoring document template, which includes embedded labels that are interpretable by the processor, to a user device. The processor receives, from the user device, a completed web authoring document comprising the web authoring document and text having at least one of the embedded labels associated with the text. The processor compiles the completed web authoring document to generate at least one guided knowledge capture web page with embedded knowledge capture logic corresponding to the text and the embedded labels associated with the text. The processor generates a customized knowledge capture website from the at least one guided knowledge capture web page, such that the customized knowledge capture website is accessible from the user device.

### RELATED APPLICATIONS

This application claims priority to U.S. Provisional Patent Application Ser. No. 62/898,222 filed on Sep. 10, 2019, the entire disclosure of which is hereby expressly incorporated by reference.

### BACKGROUND

### Technical Field

The present disclosure relates generally to the field of computer knowledge capture systems. More specifically, the present disclosure relates to computer systems and methods for automatically generating customized knowledge capture websites using word processor authoring tools.

### Related Art

A web-based application is a client-server computer program that executes in a web browser, and includes a user interface and client-side logic. Generating a web-based application is often a difficult and time-consuming processes that requires specific knowledge of computer programming and coding.

Recent innovations have provided users with cloud-based application building platforms. However, these platforms can be complicated and cumbersome to operate. Moreover, existing platforms often require the user to learn and utilize one or more programming languages in order imbue desired functionality to such platforms. Such a drawback is especially palpable where the user desires to imbue knowledge capture functionality in a platform, and must learn one or more complex and often esoteric knowledge capture programming languages in order to implement knowledge capture functionality. Therefore, there is a need for systems and methods for generating web-based applications using approachable and simple authoring tools which allow the user to easily implement knowledge capture functionality in a web-based application. These and other needs are addressed by the computer systems and methods of the present disclosure.

### SUMMARY

The present disclosure relates to computer systems and methods for automatically generating customized knowledge capture websites and/or web applications using word processor authoring tools. Specifically, the system generates a web authoring document using a word processor. The web authoring document is authored and customized by a user using customized document labels that are pre-defined in a word processor program. Specifically, a user inputs desired data, e.g., phrases, information, questions, answers, etc., into the web authoring document and applies customized labels to the data using customized label buttons. The customized label buttons apply specific logic to the text that is understood by a web interface modeling engine. The system then transmits the web authoring document to a web interface authoring platform that includes the web interface modeling engine. Next, the system compiles the web authoring document at the web interface authoring platform using the web interface modeling engine to automatically generate guided knowledge capture web pages and/or web applications with embedded knowledge capture logic. Each guided knowledge capture web page/application can include instructional information, notes/messages, questions with interactive answer/choice buttons, etc., which are created based on the customized labels implemented in the web authoring document. The system then generates a customized knowledge capture website from the knowledge capture web pages and/or web applications and allows the user to access and utilize the customized knowledge capture website. The knowledge capture logic can record the selections made/answers provided on each guided knowledge capture web page/application, and advance the user to further guided knowledge capture web pages/applications based on the selections made/answers provided.

### BRIEF DESCRIPTION OF THE DRAWINGS

The foregoing features of the invention will be apparent from the following Detailed Description, taken in connection with the accompanying drawings, in which:

FIG. 1 is a diagram illustrating the overall system of the present disclosure;

FIG. 2 is a flowchart illustrating overall process steps carried out by the system of the present disclosure;

FIG. 3 is a flowchart illustrating step 32 of FIG. 2 in greater detail;

FIG. 4 is a flowchart illustrating step 36 of FIG. 2 in greater detail;

FIGS. 5A-5K are screenshots illustrating generation of a web authoring document using a word processor in connection with step 32 of FIG. 2;

FIGS. 6A-6D are screenshots illustrating steps for generating customized knowledge capture web pages/applications in connection with step 36 of FIG. 2;

FIGS. 7A-7D are screenshots illustrating steps for generating a customized knowledge capture website, in connection with step 38 of FIG. 2;

FIGS. 8A-8E are screenshots of the customized knowledge capture websites generated by the web interface authoring platform from the web authoring document created in FIGS. 4A-4K, as used by the user in connection with step 40 of FIG. 2; and

FIG. 9 is a flowchart illustrating process steps for implementing an auto-styling module.

### DETAILED DESCRIPTION

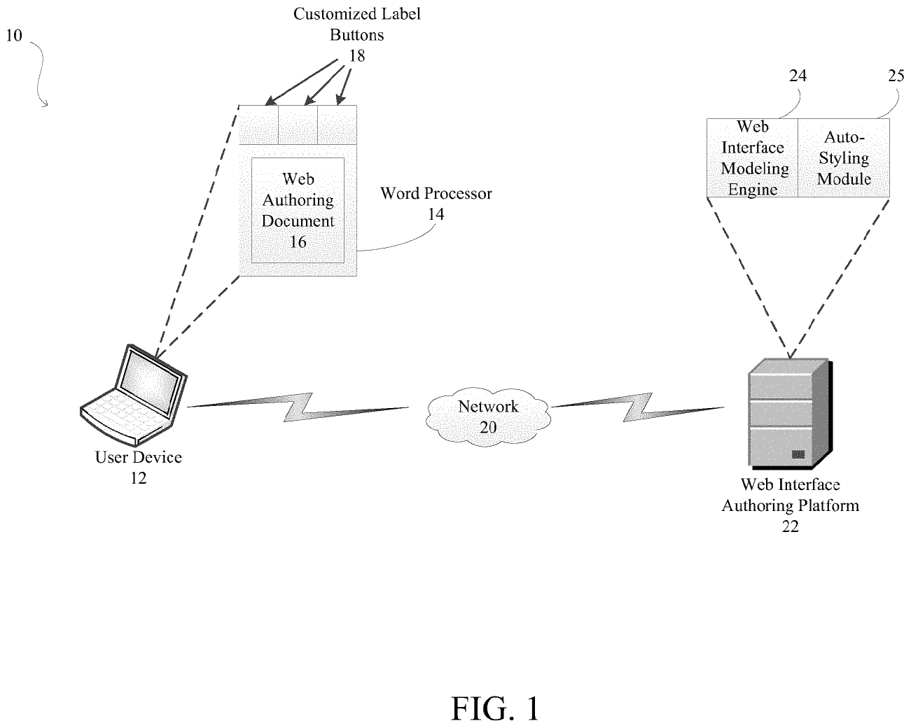

The present disclosure relates to systems and methods for automatically generating customized knowledge capture websites and/or web applications using word processor authoring tools, as described in detail below in connection with FIGS. 1-9.

FIG. 1 is a diagram illustrating the system of the present disclosure, indicated generally at 10. The system 10 includes a user device 12, a network 20, and a web interface authoring platform 22. The user device 12 can be any electronic device such as a personal computer, a desktop computer, a tablet computer, mobile phone, a smartphone, a phablet, an embedded device, a wearable device, a field-programmable gate array (“FPGA”), an application-specific integrated circuit (“ASIC”), etc. The user device 12 can execute a word processor 14, such as, for example, Microsoft® Word, WordPerfect®, LibreOffice®, etc. The word processor 14 can be used to generate a web authoring document 16 using customized label buttons 18. The web interface authoring platform 22 can execute a web interface modeling engine 24 and an auto-styling module 25. The user device 12, word processor 14, web authoring document 16, customized label buttons 18, the web interface modeling engine 24, and the auto-styling module 25 will be discussed in further detail below.

The user device 12 and the web interface authoring platform 22 can be connected to the network 20 such that the web interface authoring platform 22 can receive data via the network 20 from the user device 12. The network 20 can be any type of wired or wireless network, including but not limited to, a radio access network (“RAN”), a Long Term Evolution radio access network (“LTE-RAN”), a wireless local area network (“WLAN”), such as a WiFi network, an Ethernet connection, or any other type network used to support communication. For example, the user device 12 can be connected to the web interface authoring platform 22 via a wireless network connection (e.g., Bluetooth, WiFi, LTE-RAN, etc.). The web interface authoring platform 22 can be any type of server used for executing the web interface modeling engine 24. Those skilled in the art would understand that the user device 12 can also execute the web interface modeling engine 24. Alternatively, the web interface modeling engine 24 could be on the cloud.

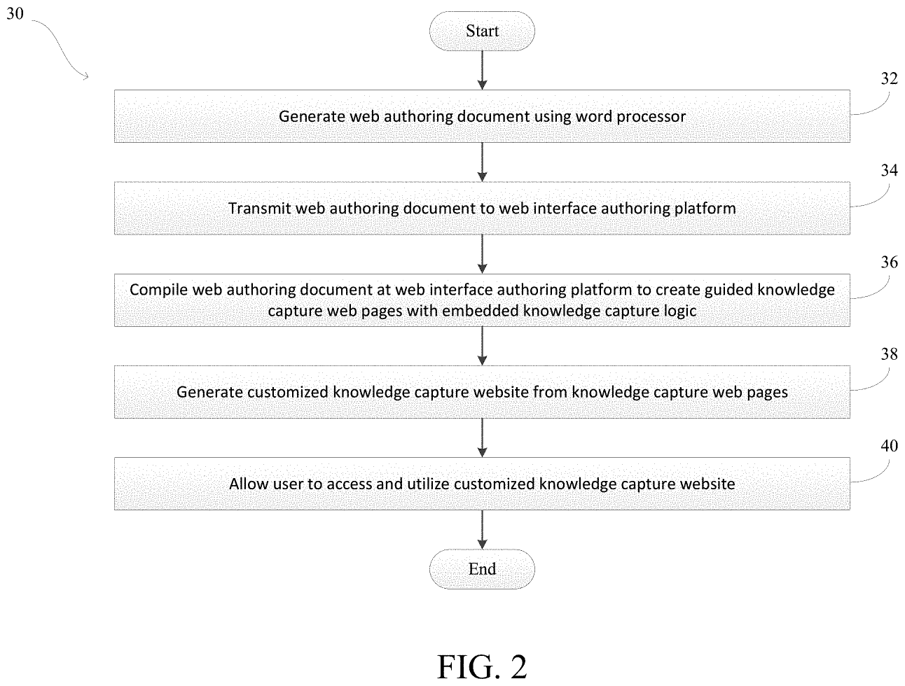

FIG. 2 is a flowchart illustrating the overall process steps being carried out by the system 10, indicated generally at method 30. In step 32, the system 10 generates the web authoring document 16 using the word processor 14, which can be customized by a user. For example, the user can input text into the document 16 and customize the text (e.g., words, sentences, paragraphs, etc.) using the customized label buttons 18, which apply a custom label to and associate metadata with selected text. For example, the labels can be, but are not limited to, customized styles that can be applied to the text and viewable by the user. Each label and metadata can be interpreted by the web interface modeling engine 24 to produce a different section or interactive feature in a knowledge capture web page/application based on the metadata, which will be discussed in greater detail below. The user can enter the input text using an input device (e.g., a keyboard, a touchscreen, etc.), a speech-to-text module, or any other device/system capable of interpreting input to generate text.

In step 34, once the web authoring document 16 is completed, the system 10 transmits the web authoring document 16 to the web interface authoring platform 22 (e.g., via the network 20). For example, the user can upload the web authoring document 16 to the web interface authoring platform using a secured web page, a web application, etc.

In step 36, the system 10 compiles the web authoring document 16 at the web interface authoring platform 22 to generate guided knowledge capture web pages and/or web applications with embedded knowledge capture logic. Specifically, the web interface modeling engine 24 processes the web authoring document 16, determines the custom label and metadata applied to each text portion of the web authoring document 16, and translates each custom label into a corresponding guided knowledge capture web page/application, as well as any subcomponent of such web page/application, including one or more of paragraphs, sections, headings, titles, questions, etc. Each different custom label can correlate to an individual guided knowledge capture web page/application comprising one or more of instructional information, notes/messages, and/or questions with interactive answer/choice buttons (e.g., a multiple choice button(s), a text entry box(es), a drop down list(s), a yes/no or true/false button(s), etc.), among other options. Moreover, it should be understood that each text portion need not be translated into its own individual guided knowledge capture web page/application, but instead multiple text portions each having their own label can be provided on the same guided knowledge capture web page/application such that a user can view multiple subcomponents at the same time and scroll through the multiple subcomponents.

The knowledge capture logic can record user input (e.g., the selections made/answers provided on each guided knowledge capture web page/application) and advance the user to further guided knowledge capture web pages/applications based on the selections made/answers provided. For example, if a question on a first guided knowledge capture web page/application comprises three presented answers, selecting the first answer can progress the user to a second guided knowledge capture web page/application, selecting the second answer can progress the user to a third guided knowledge capture web page/application, and selecting the third answer can progress the user to a fourth guided knowledge capture web page/application. Each of the second, third, and fourth guided knowledge capture web pages/applications can comprise further instructional information, notes/messages, and/or questions with interactive answer/choice buttons.

In step 38, the system 10 generates a customized knowledge capture website from the individual knowledge capture web pages/applications. For example, the system 10 can generate an interactive and browse-able website for display to the user. In step 40, the system allows the user to access and utilize the customized knowledge capture website, which can be accessed via the user device 12. The customized knowledge capture website may also be referred to as an “application” throughout the present disclosure.

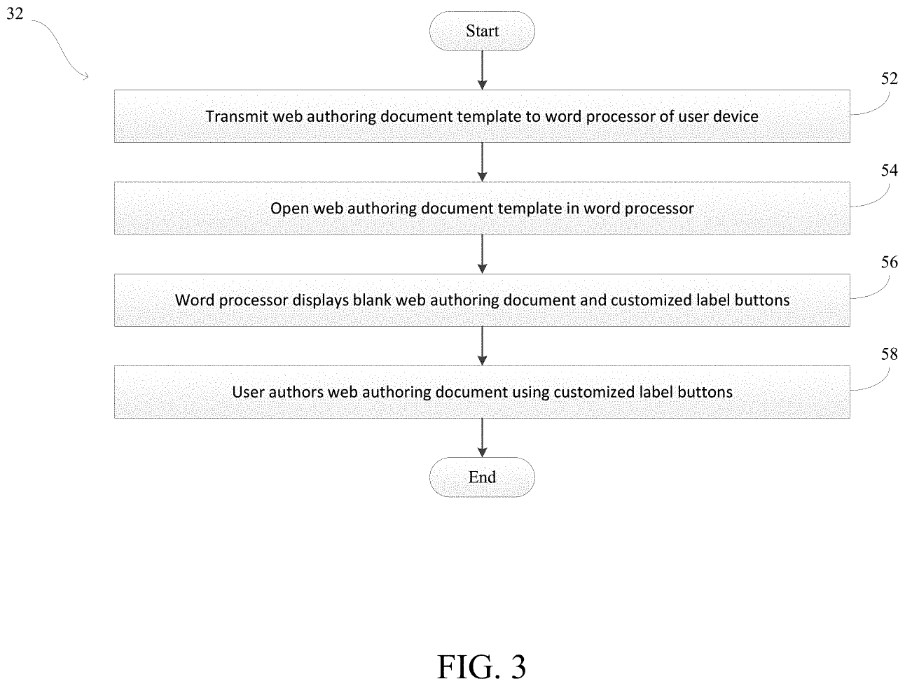

FIG. 3 is a flowchart illustrating step 32 of FIG. 2 in greater detail, which relates to generating the web authoring document 16 using the word processor 14. In step 52, the system 10 transmits the web authoring document template to the word processor 14 of the user device 12. The web authoring document template can be a blank word processing document, a template word processing document, an imported word processing document, or any other type of word processing document. In either instance, the web authoring document template includes the customized label buttons 18 embedded therein, which allow a user to apply custom labels to any text input into the web authoring document 16. In step 54, the system 10 opens the web authoring document template in the word processor 14.

In step 56, the word processor 14 displays a blank web authoring document 16 and the customized label buttons 18. The customized label buttons 18 can be any type of button having a customized label associated therewith, and can also change the font, color, size, position, style (e.g., bold, italics, underlined, strikethrough, etc.) or any other feature of the text. For example, as previously noted, the customized label buttons 18 can each have a particular style associated therewith. Furthermore, each of the customized labels associated with a customized label button 18 has a specific functionality associated therewith that can be interpreted by the web interface modeling engine 24.

In step 58, the user authors the web authoring document 16 and customizes it using the customized label buttons 18. By way of example, the user can use a speech-to-text module to customize the web authoring document 16. Specifically, the user can recite subject matter into the speech-to-text module, which will transcribe the recited subject matter into written text. Additionally, the user can indicate, via speech, which customized label is to be associated with each recitation of subject matter. For example, the user can say “question” and the module will understand that the words following should have the question label applied. In another example, the system 10 can automatically determine a customized label for different recitations of subject matter based on the user's tone and/or content of the recited subject matter. For example, the system 10 can use a neural network(s) and/or a machine learning system to determine/understand whether the recited subject matter is a statement, a question, an answer, etc., based on a tone of the user used to dictate the subject matter, and/or based on content of the recited subject matter. Once the web authoring document 16 is completed, the user or system 10 proceeds to step 34 of FIG. 2, as discussed above.

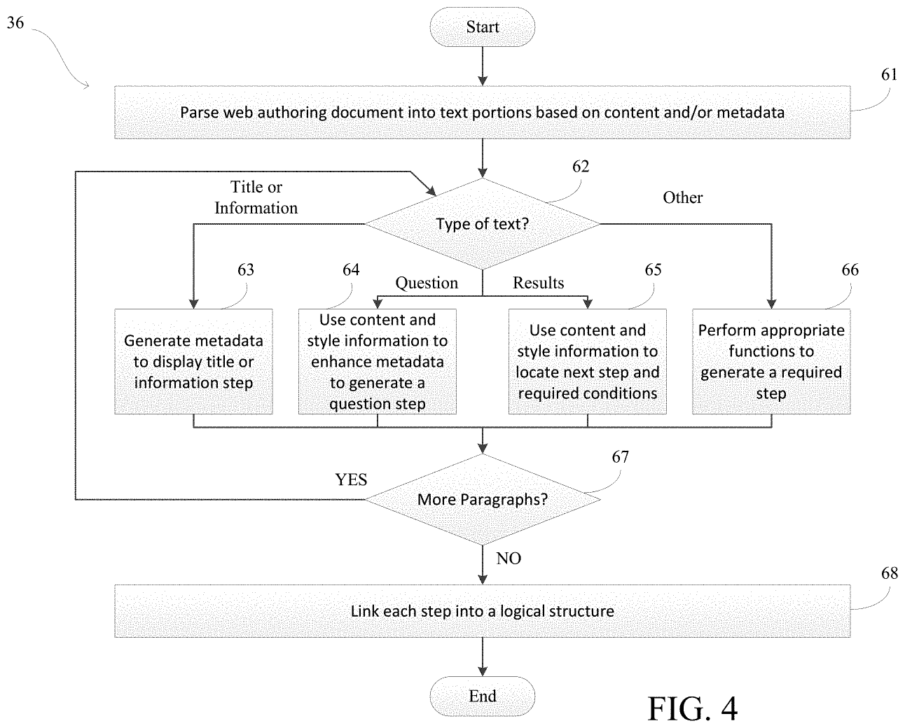

FIG. 4 is a flowchart illustrating step 36 of FIG. 2 in greater detail, which relates to compiling the web authoring document 16 at the web interface authoring platform 22 to generate the guided knowledge capture web pages/applications with embedded knowledge capture logic. In step 61, the system 10 parses the web authoring document 16 into paragraphs or individual portions (e.g., words, lines, etc.) based on content and/or metadata associated with each of the paragraphs. Accordingly, it should be understood that any reference herein to a paragraph is also a reference to individual text portions, including parsing a larger paragraph into multiple individual text portions. In step 62, the system 10 determines a type for each of the parsed paragraphs based on the metadata associated with that paragraph. In this regard, during creation of the web authoring document 16, application of a label to a paragraph causes metadata to be associated with that paragraph, including data related to the applied label and parseable by the web interface modeling engine 16. Specifically, the web interface modeling engine 24 identifies stylistic elements based on the associated metadata (e.g., in connection with the customized labels associated with a customized label button 18) and content elements (e.g., syntax, grammar, etc.) in each of the parsed paragraphs of the web authoring document 16 to generate each step of a workflow. The type of paragraph can include a title paragraph, an information paragraph, a question paragraph, a result paragraph, or other types of paragraphs.

In step 62, if the interface modeling engine 24 determines that a parsed paragraph is a title paragraph or an information paragraph, then the interface modeling engine 24 proceeds to step 63, where the interface modeling engine 24 generates metadata to display a title or information step of the workflow. For example, for the title or information step, the web interface modeling engine 24 is programmed to automatically determine that input is not required from the user and the information only needs to be displayed in the component.

In step 62, if the interface modeling engine 24 determines that a parsed paragraph is a question paragraph, then the interface modeling engine 24 proceeds to step 64, where the interface modeling engine 24 uses content (e.g., string parsing) and label information to enhance metadata to generate a question step. Specifically, the interface modeling engine 24 generates metadata to display a question step of the workflow, and locates the answers and/or next steps which are linked to the question(s), which is achieved by cycling through the relevant parsed paragraphs. That is, the metadata associated with the question label informs the interface modeling engine 24 that an answer should follow. In step 62, if the interface modeling engine 24 determines that a parsed paragraph is a results paragraph, then the interface modeling engine 24 proceeds to step 65, where the interface modeling engine 24 uses content (e.g., string parsing) and label information to locate next steps and conditions for displaying a result based on previous steps.

For example, the web interface modeling engine 24 can determine from the stylistic and content elements that a paragraph of the web authoring document 16 contains a question asked, information to be presented along with the question, and a result that is based on a response to the question. For the question label, the web interface modeling engine 24 is programmed to automatically determine that an answer is required, and can display answer options to the user. The answer options can be drafted in the web authoring document 16 as types of answers (e.g., using a label), and can be predefined (e.g., a name, a date, a number, etc.) and recognized by the web interface modeling engine 24 as answer options to be presented to the user. If the question requires free text options, then these options will be displayed by the web interface modeling engine 24 to the user as text options to choose from. The web interface authoring platform 22 then generates appropriate steps from the identified content elements and stylistic elements, e.g., based on the metadata, which are used to create the workflow, which is explained in greater detail below in step 68.

As noted above, the customized labels that can be applied to the web authoring document are not limited strictly to title, information, question, and results labels, but instead any other desirable label, e.g., actions such as alerts (email, SMS, etc.), document uploading/downloading, clearance approval/revocation, hardware activation (e.g., microphone) or other operational functionality, can be developed, implemented, and applied, so long as the interface modeling engine 24 is configured to parse and understand the metadata associated with such label. Regarding operational functionality, the system 10 can execute actions based on an applied label, user input, and/or user responses to questions from the knowledge capture website. In a first example, if a user answers that they have not received a compliance manual, the system 10 can automatically download a compliance manual for that user. In a second example, if the user answers that they have not read the compliance manual, the system 10 can disable/suspend the user's access/clearance to the company's materials or restricted areas. However, it should be understood that the foregoing are mostly exemplary in nature and other operational functionality could be implemented by way of a specific label.

Accordingly, in step 62, if the interface modeling engine 24 determines that a parsed paragraph is an “other” type of predetermined paragraph label, e.g., not a title, information, question, or result label, then the interface modeling engine 24 proceeds to step 66, where the interface modeling engine 24 performs the appropriate functions to generate the required step. In step 67, the system 10 determines whether there are any more parsed paragraphs. If yes, then the system 10 proceeds to step 62. If no, then the system 10 proceeds to step 68.

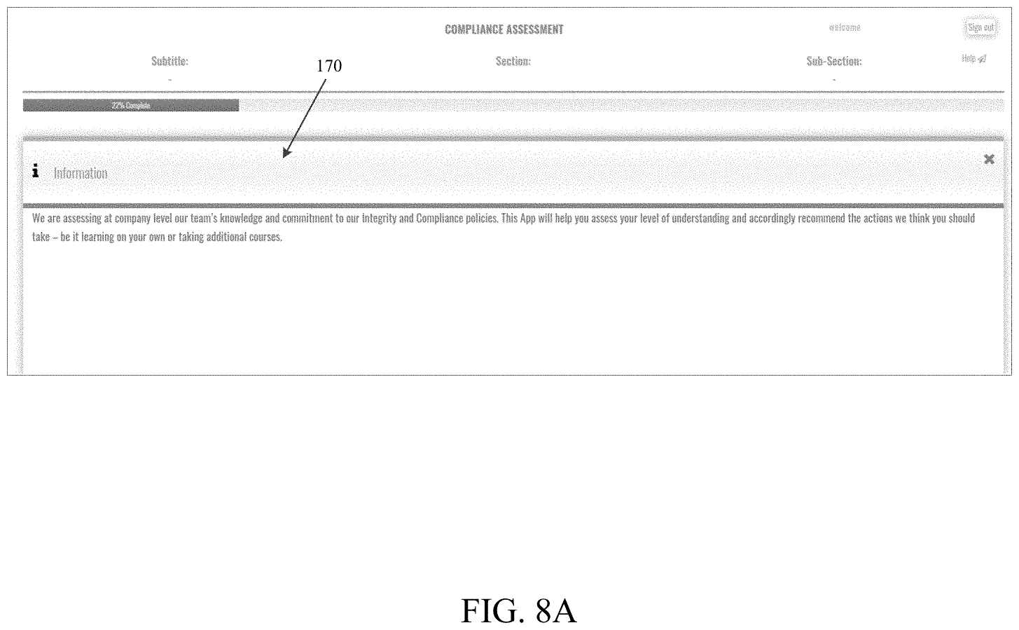

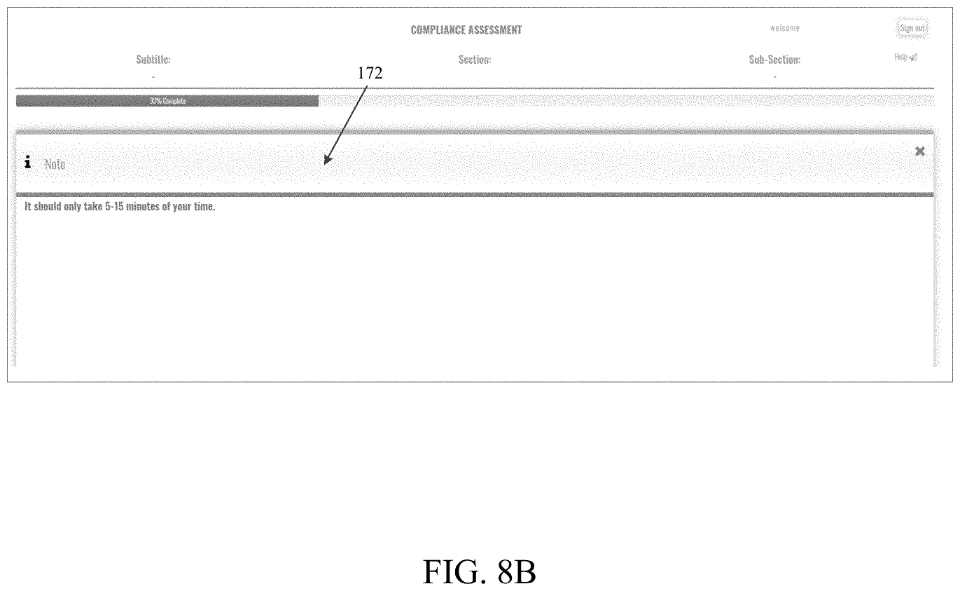

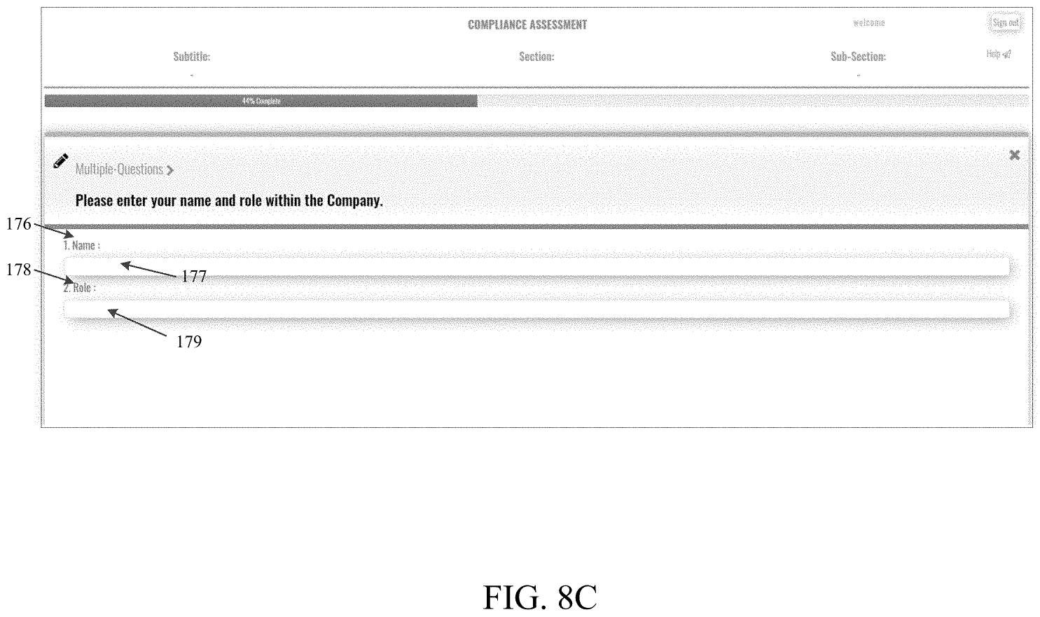

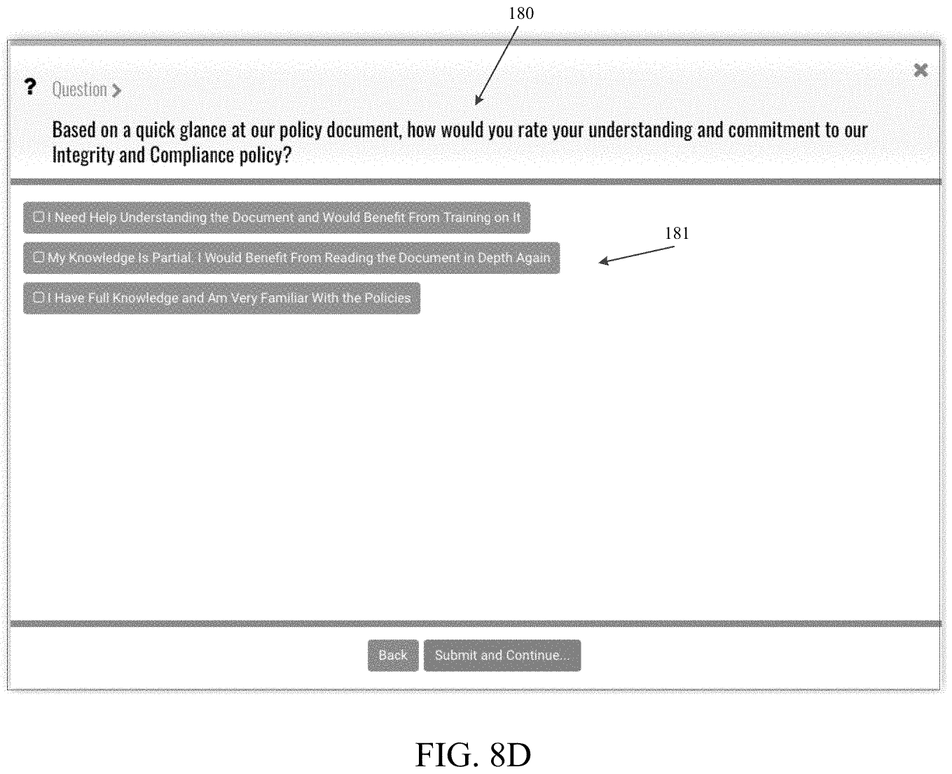

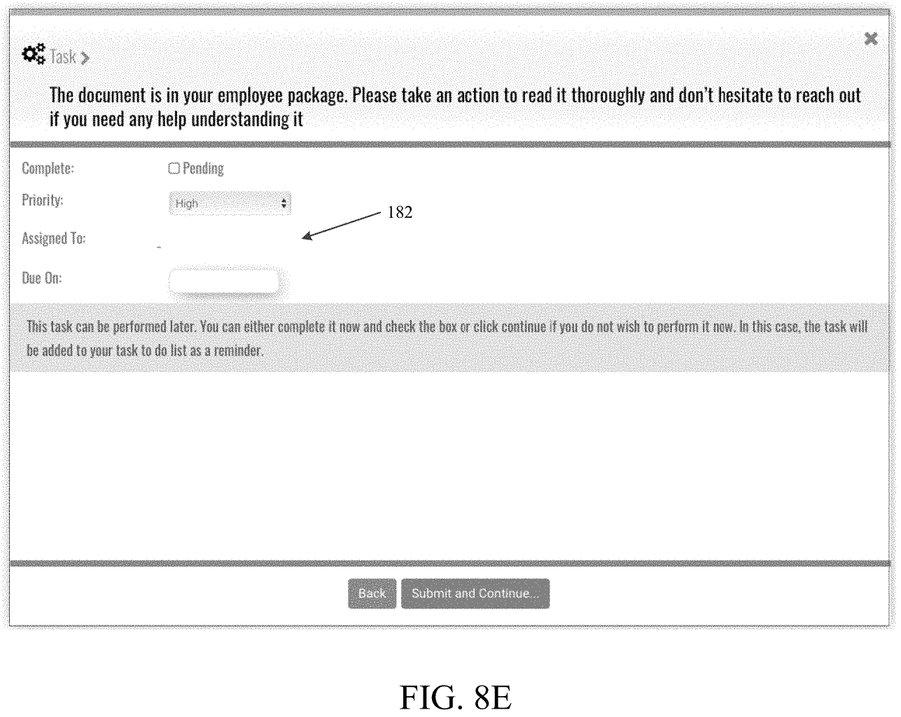

In step 68, the web interface modeling engine 24 links the steps into a logical structure. Specifically, the web interface modeling engine 24 builds a workflow and generates elements on each page of the workflow by utilizing metadata, stylistic information from the stylistic elements, and/or syntactic information from the web authoring document 16. For example, the web interface modeling engine 24 can connect information to a related question and results to questions they stem from. The web interface modeling engine 24 can also connect sequential steps, e.g., based on the structure of the web authoring document 16. The connections and the steps form an overall workflow that the web interface modeling engine 24 provides to the user through asking questions, providing information and evaluating results. The workflow that is created and shown to the user is illustrated, for example, in FIGS. 8A-8E. It should be understood that step 68 could occur prior to or after step 67. For example, it is within the scope of the present disclosure for the system to link each step into a logical structure (step 68) prior to determining if there are more paragraphs in step 67.

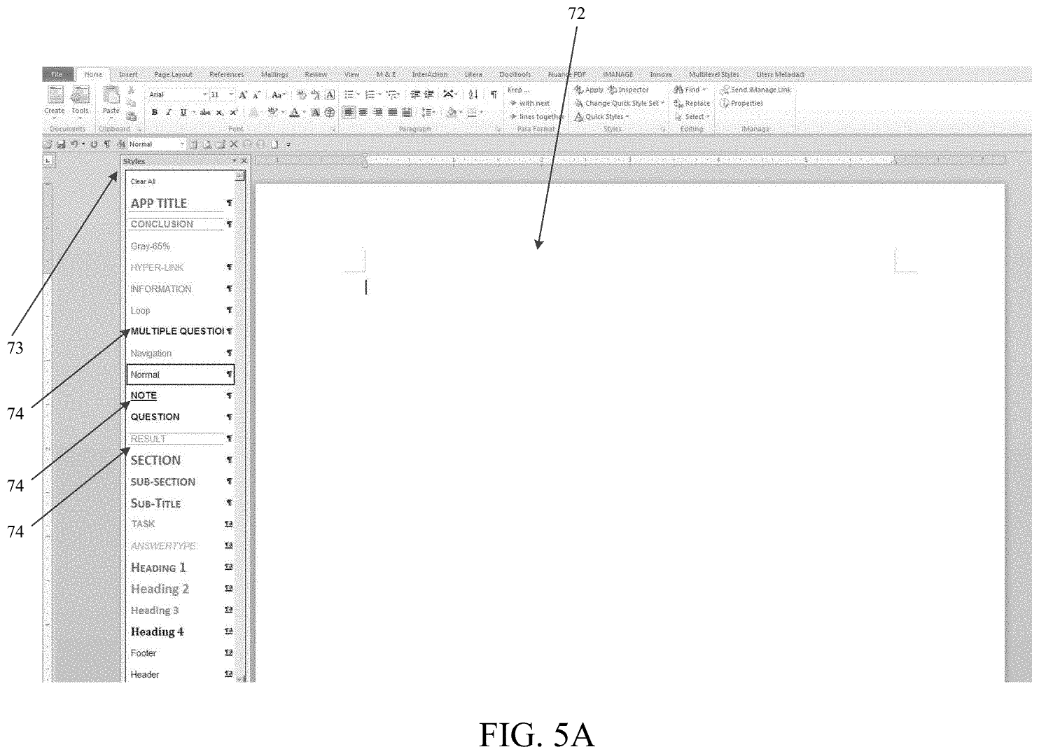

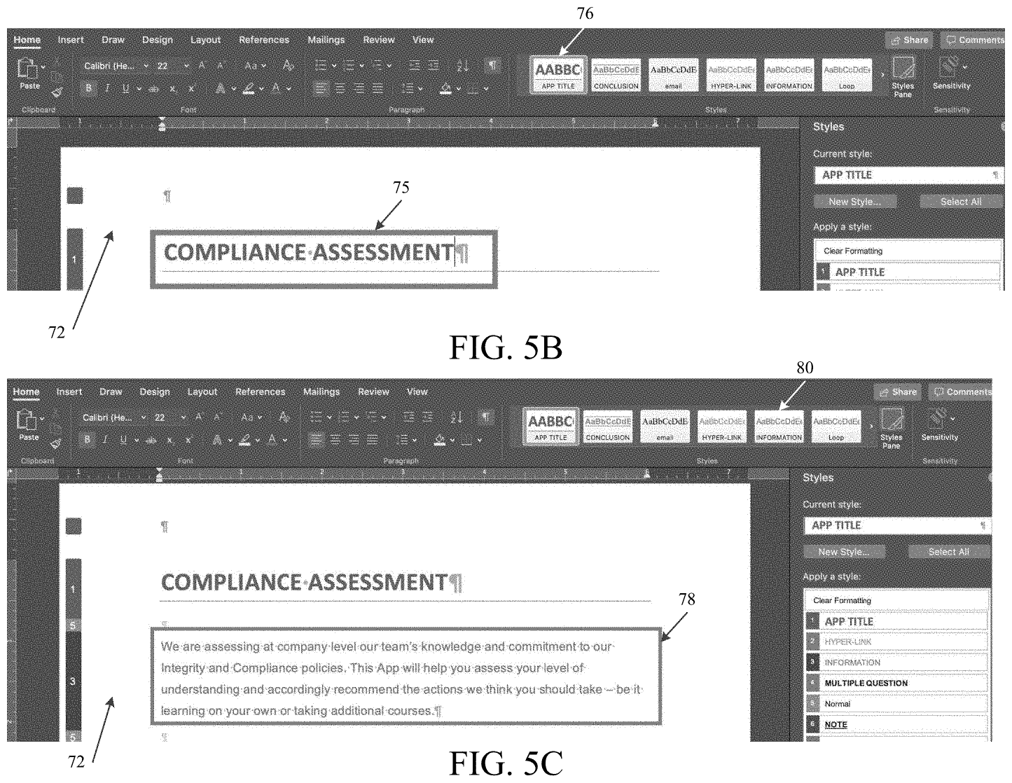

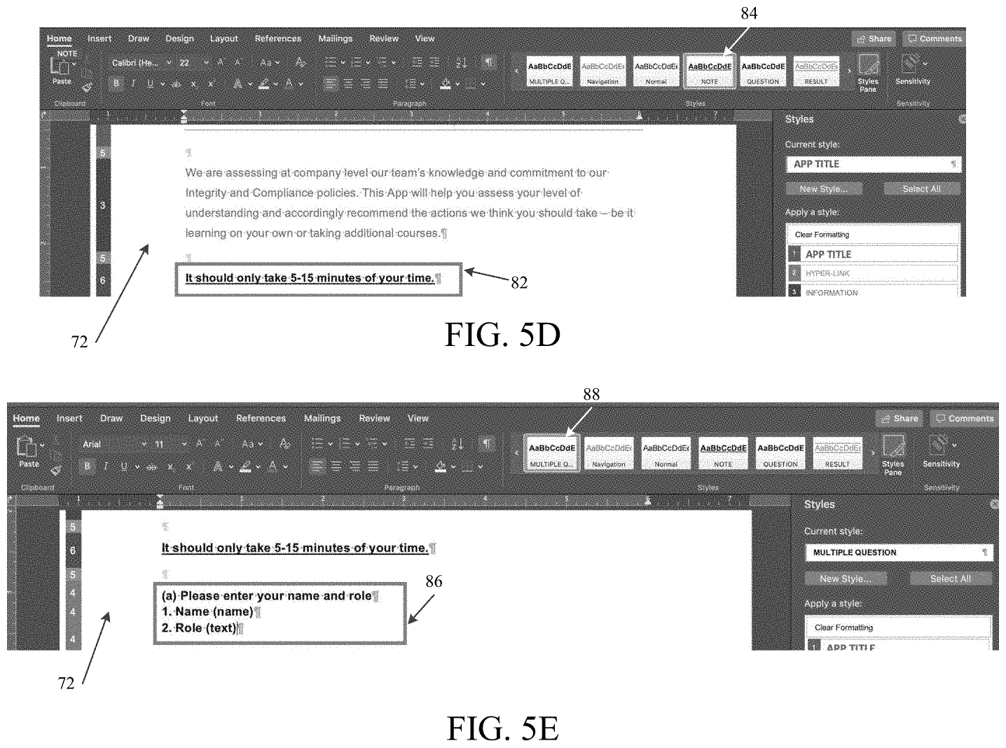

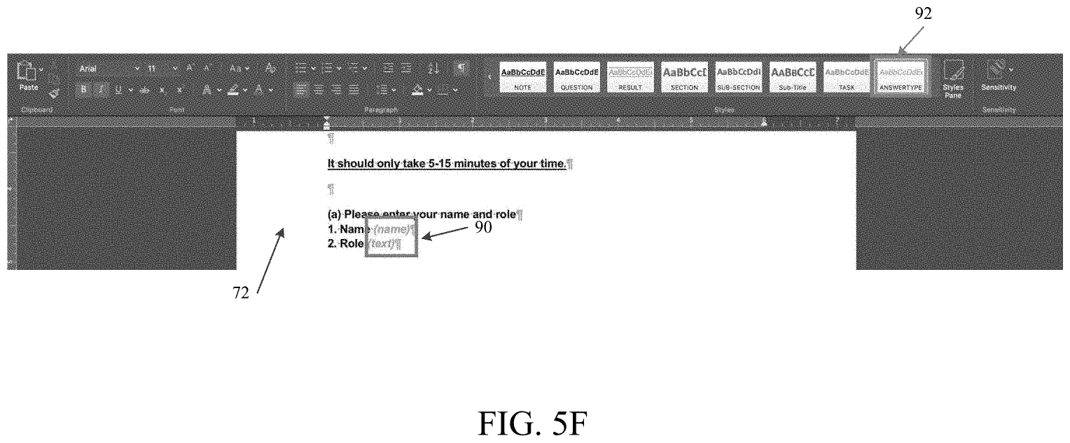

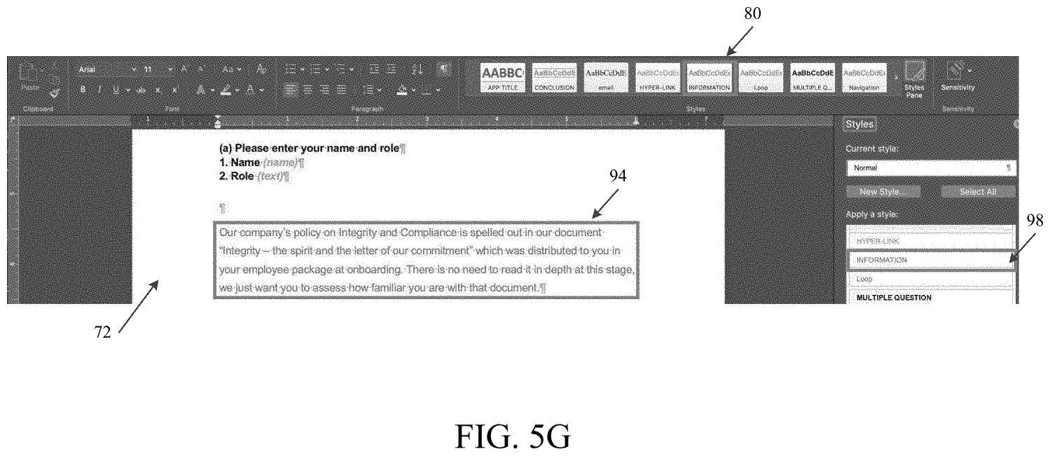

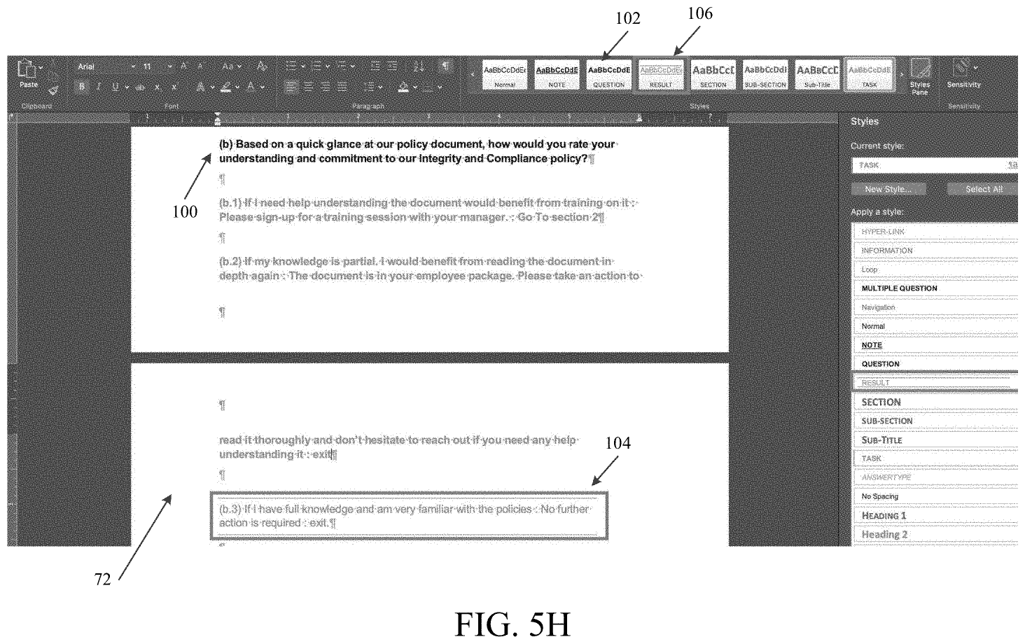

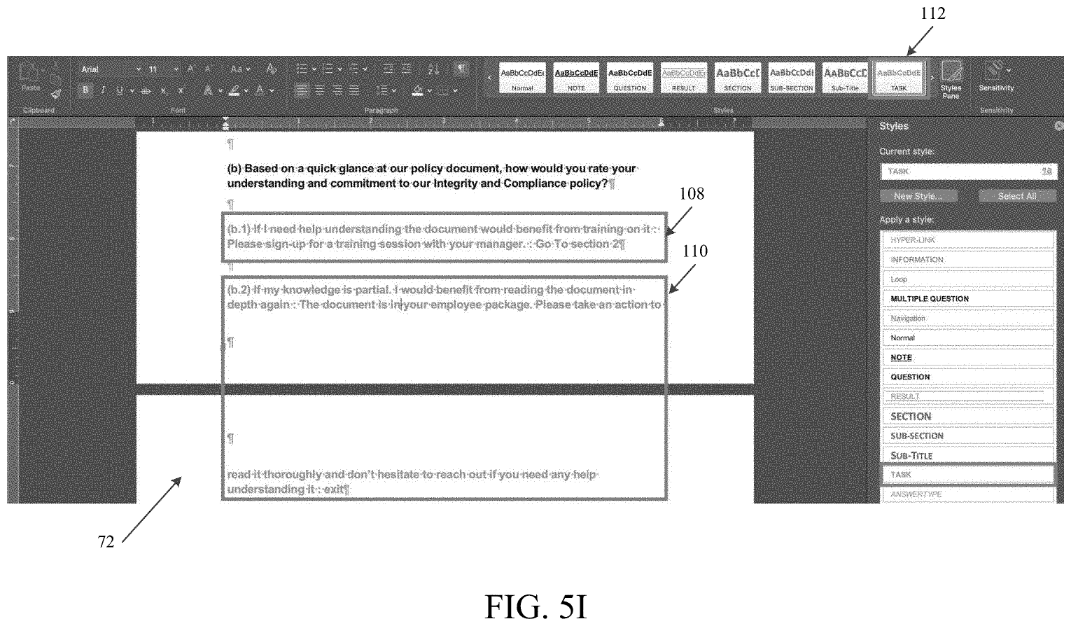

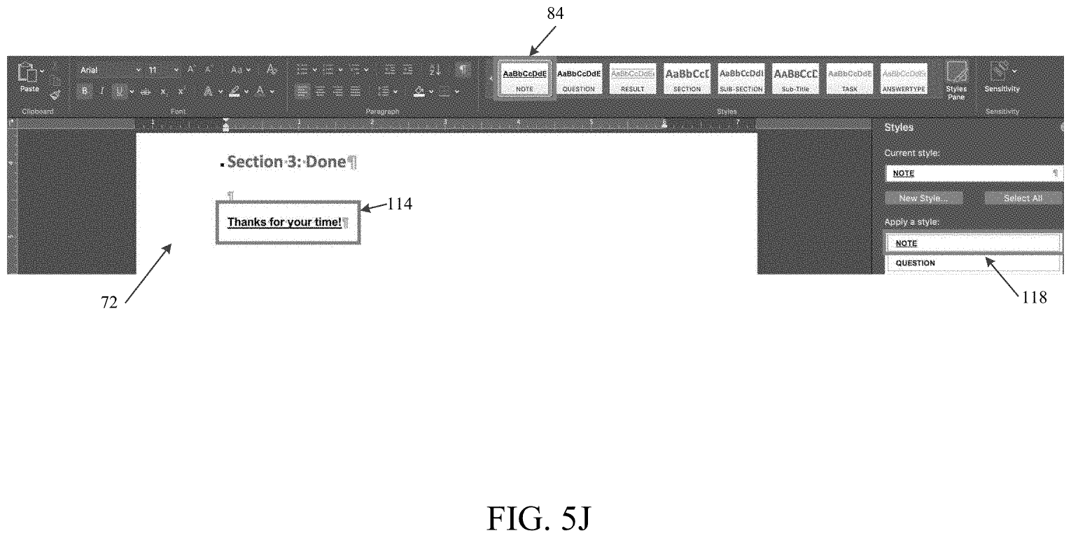

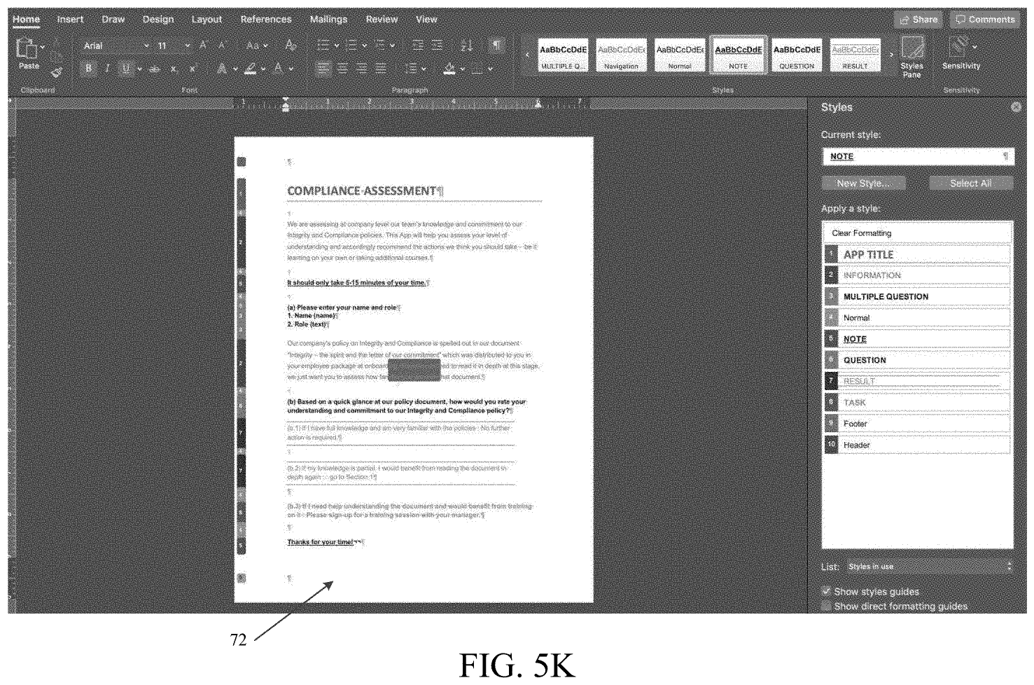

FIGS. 5A-5K are screenshots illustrating generation of the web authoring document using the word processor 14 in connection with step 32 of FIG. 2. Specifically, FIGS. 5A-5K demonstrate generating a “compliance assessment” web authoring document. FIG. 5A shows a blank web authoring document 72 with a panel graphical user interface (“GUI”) 73. The word processor 14 provides a panel 73 used to present customized GUI label buttons 74 amongst non-customized label or style buttons already present. FIG. 5B shows the web authoring document 72 with a title 74 input by a user and set to a first label using a first label button 76. Title 75 reads “Compliance Assessment” and the first label associated with the first label button 76) is an “APP-TITLE” label. FIG. 5C shows the web authoring document 72 with a paragraph 78 input by the user and set to a second label using a second label button 80. Paragraph 78 reads “We are assessing at company level our team's knowledge and commitment to our Integrity and Compliance program. This App will help assess your level of understanding and accordingly recommend the action we think you should take—be it learning on your own or taking additional courses,” while the second label associated with the second label button 80 is an “INFORMATION” label. FIG. 5D shows the web authoring document 72 with a sentence 82 input by the user and set to a third label using a third label button 84. Sentence 82 reads “It should only take 5-15 minutes of your time” and the third label associated with label button 84 is a “NOTE” label.

FIG. 5E shows the web authoring document 72 with a multiple question text 86 input by the user and set to a fourth label using a fourth label button 88. Multiple question text 86 reads “(a) Please enter your name and role 1. Name: (Name) 2. Role: (Text)” and the fourth label associated with the fourth label 88 is the “QUESTION” label. FIG. 5F shows the web authoring document 72 with a “(Name)” and “(Text)” portion 90 of multiple question text 86 input by the user and set to a fifth label using a fifth label button 92, which is an “ANSWERTYPE” label. FIG. 5G shows the web authoring document 72 with a paragraph 94 input by the user and set to the “INFORMATION” label, which can be selected using the second label button 80 located in the top-bar, or using a second label button 98 located in the side-bar. Paragraph 94 reads “Our company's policy on Integrity and Compliance is spelled out in our document ‘Integrity—the spirit and the letter of our commitment’ which was distributed to you in your employee package at onboarding. There is no need to read it in depth at this stage, we just want you to assess how familiar you are with that document.”

FIG. 5H shows the web authoring document 72 with a question 100 input by the user and set to a sixth label using a sixth label button 102, as well as a third answer 104 set to a seventh label using a seventh label button 106. Question 100 reads “(b) Based on a quick glance at our policy document, how would you rate your understanding and commitment to our Integrity and compliance policy?” The sixth label associated with the sixth label button 102 is a “QUESTION” label. The third answer 104 reads “(b.3). If I have full knowledge and am very familiar with the policies: No further action is required.” The seventh label associated with the seventh label button 106 is a “RESULT” label. FIG. 5I shows the web authoring document 72 with a first answer 108 and second answer 110 input by the user and set to an eighth label associated with an eighth label button 112. The second answer 110 reads “(b.2) If my knowledge is partial. I would benefit from reading the document in depth again: Please take an action to read it thoroughly and don't hesitate to reach out if you need any help understanding it.” The first answer 108 reads “(b.1) If I need help understanding the document and would benefit from training on it: Please sign-up for a training session with your manager.” The eighth label associated with the eighth label button 112 is a “TASK” label. It is noted that the answers 104, 108, and 110 are drafted with an answer to the left of the colon, and a corresponding action to the right side of the colon. Selecting the third answer 104 leads the user to an outcome/result, while selecting the first answer 108 or the second answer 110 leads the user to a task.

FIG. 5J shows the web authoring document 72 with a sentence 114 input by the user and set to the third label associated the “NOTE” label, which can be selected using label button 84 located in the top-bar, or using label button 118 located in the side-bar. Sentence 114 reads “Thank you for your time!” FIG. 5K shows the completed “compliance assessment” web authoring document, that is ready to be uploaded to the web interface modeling engine 24 and compiled.

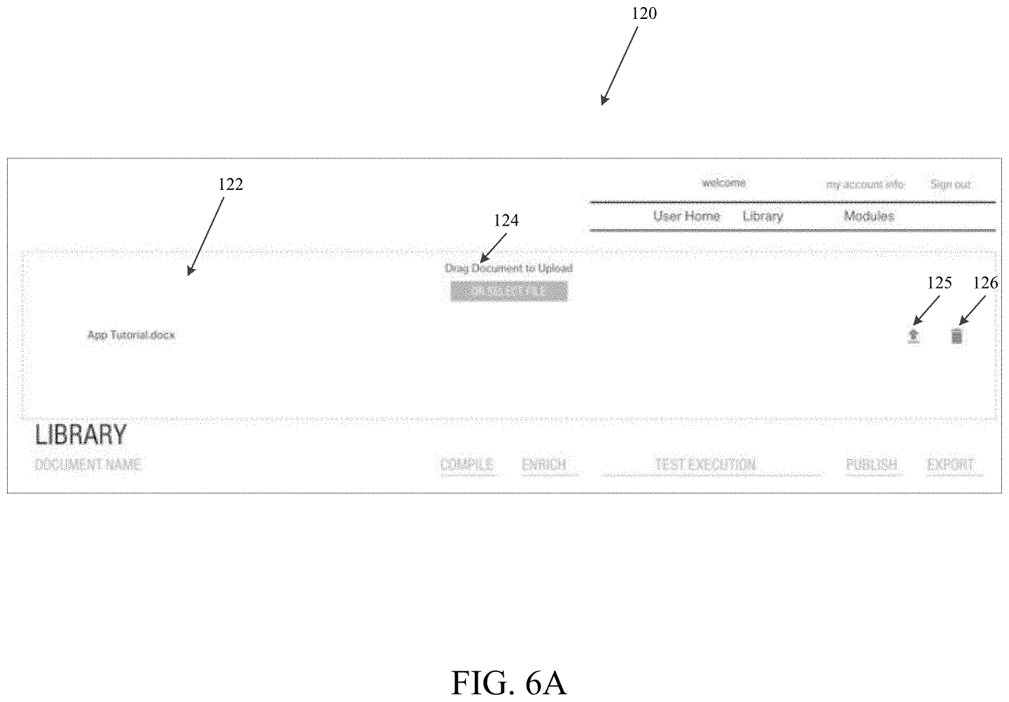

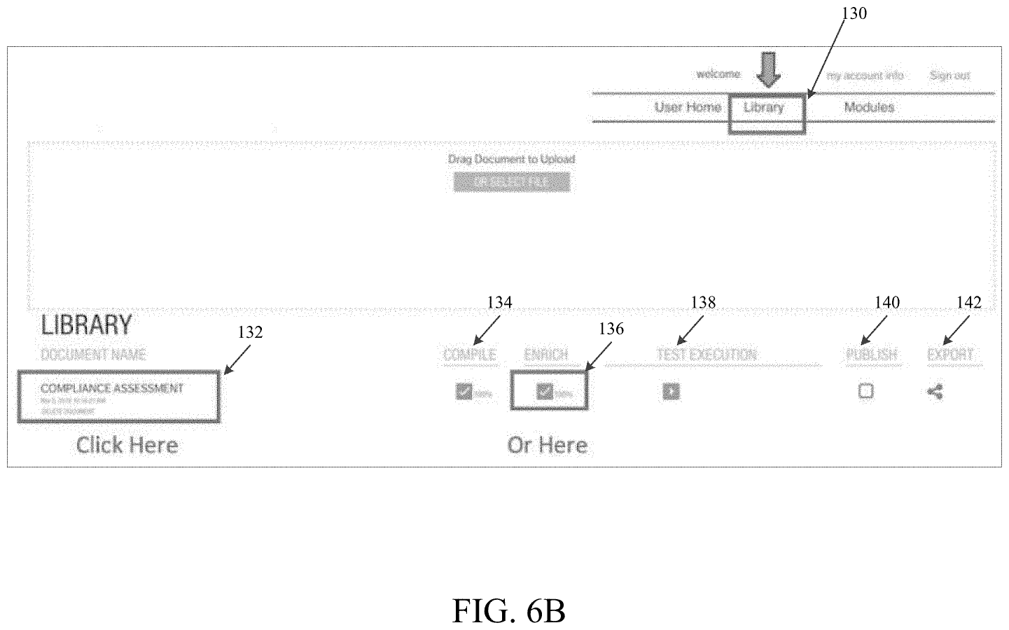

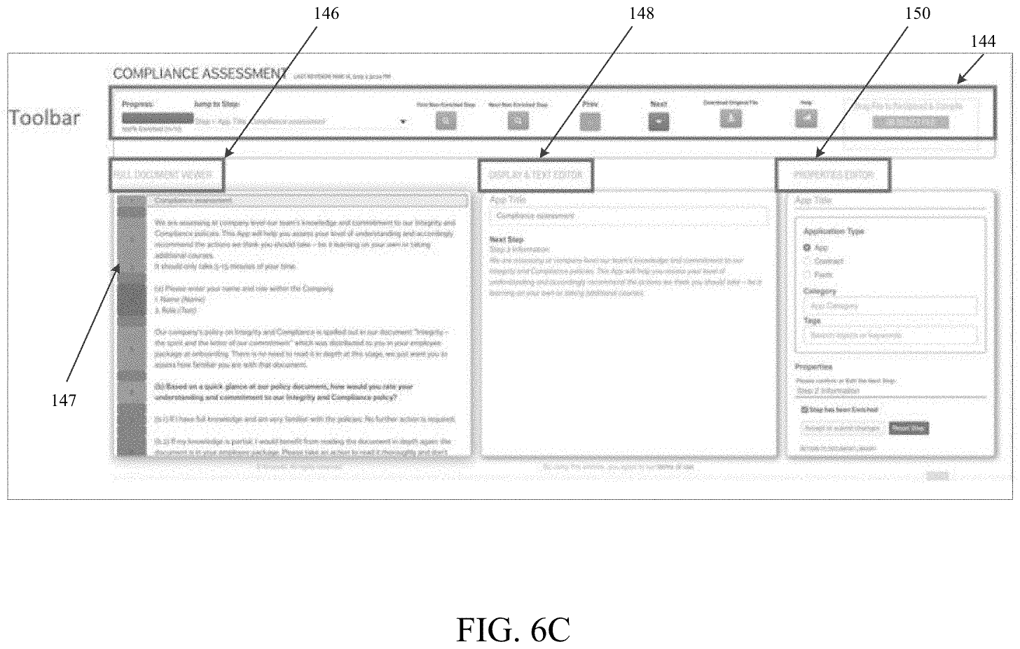

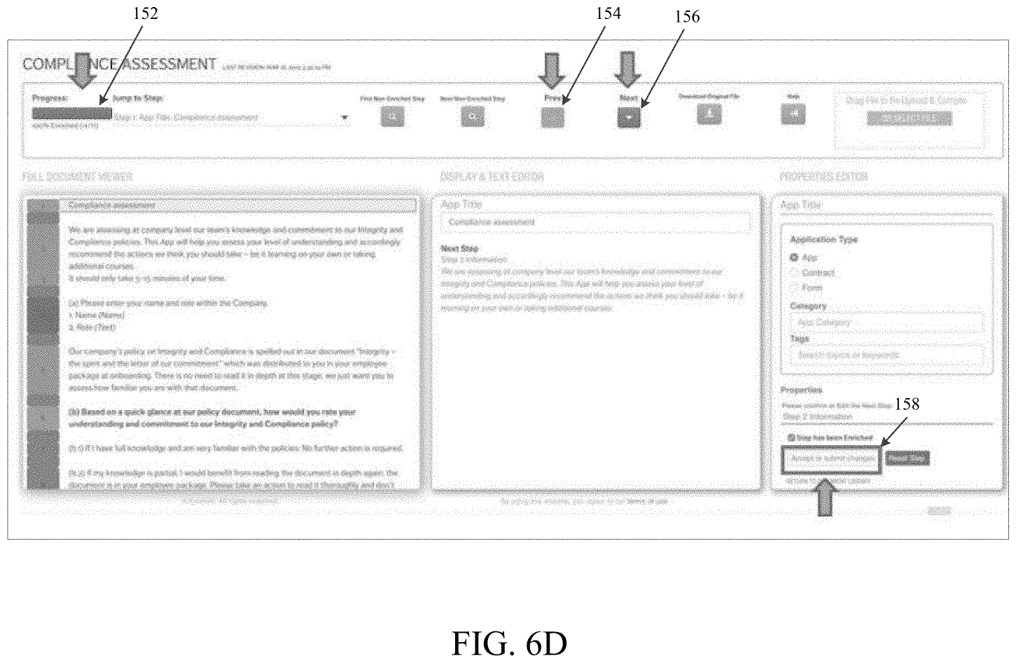

FIGS. 6A-6D are screenshots illustrating steps for generating the customized knowledge capture web pages/applications in connection with step 36 of FIG. 2. FIG. 6A shows an example interface 120 of the web interface modeling engine 24. The interface 120 comprises a document upload window 122 that allows a user to drag and drop one or more completed web authoring documents 72 into the web interface modeling engine 24 for uploading. Further, the interface 120 comprises a search button 124 to search for the web authoring documents 72 or the directory of the user device 12, an upload button 125, and a recycle button 126 to remove web authoring documents 72 from document upload window 122.

FIG. 6B shows the interface with the “compliance assessment” document 122 uploaded into a library section of the web interface modeling engine 24. The library can be accessed by selecting the library tab 130. Once uploaded, the web interface modeling engine 24 provides the user with one or more buttons/indicators relating to the document 132. The buttons/indicators include a compile indicator 134, an enrichment indicator 136, a test execution button 138, a publish indicator 140, and an export button 142. The compile indicator 134 indicates that the “compliance assessment” document 132 has been compiled. The enrichment indicator 136 indicates whether the “compliance assessment” document 132 requires enrichment. Enrichment is a step where all of the components (e.g., web pages) of a potential application (e.g., the customized knowledge capture website) (hereafter “application”) are displayed to a user as they appear in their final form, and allows the user to validate or amend the components, if necessary. For example, if there are any missing functions, they can be added during the enrichment process. The test execution button 138 displays a preview of the application. The publish button 140 gives the user the option to publish the application or not, depending on whether the publish button 140 is selected by the user. The export button 142 allows a user to export the data to the user device 12, or to a third party system/server.

FIG. 6C is a screenshot showing an enrichment screen where a user can enrich the web authoring document 72. A toolbar 144 provides the user with information regarding the application and navigation within the enrichment process. A full document viewer 146 shows the entire extracted web authoring document. A label breakdown bar 147 shows the label for text portion in the extracted web authoring document. A display and text editor 148 shows the information extracted from the web authoring document for a text portion selected in the full document viewer 146. The user is able to verify the components of the application and edit the text as desired using the enrichment screen. Specifically, the properties editor 150 allows the user to manual change and add properties to the components of the application.

FIG. 6D is another screenshot showing the enrichment screen, indicating a progress bar 152, a previous button 154, a next button 156, and an “accept or submit changes” button 158. Enrichment progress bar 152 shows how much of the enrichment has been completed. For example, the progress bar 152 will read 100% when there is no missing information. Using the previous button 154 and the next button 156, the user can navigate between enrichment screens to view the different portions of the web authoring document 72. When the user has completed the enrichment process, the user can select the “accept or submit changes” button 158 to confirm the changes.

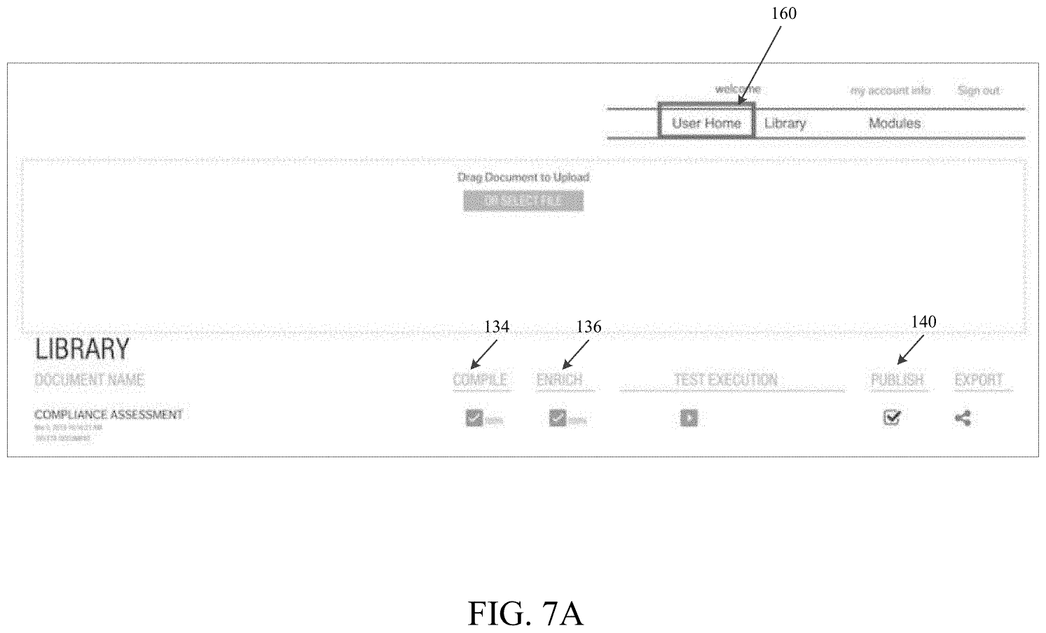

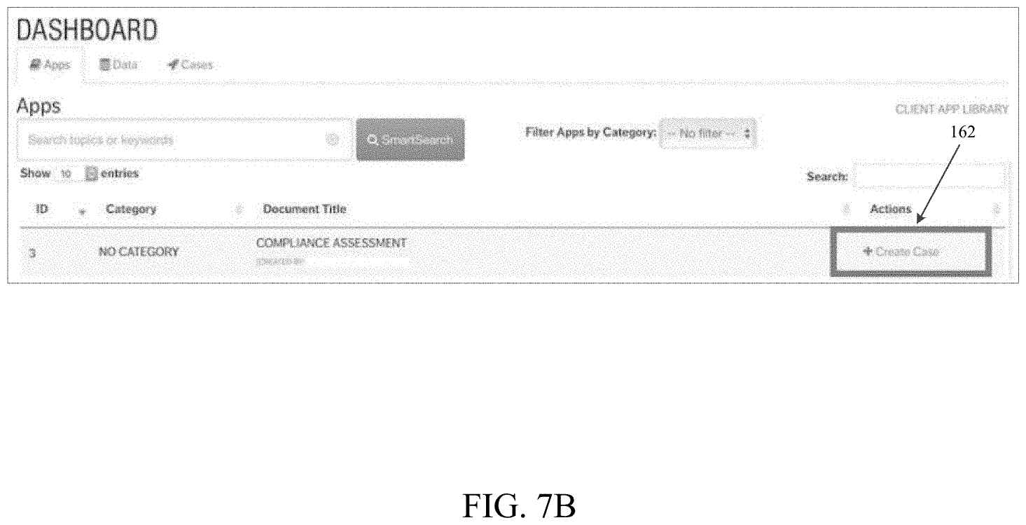

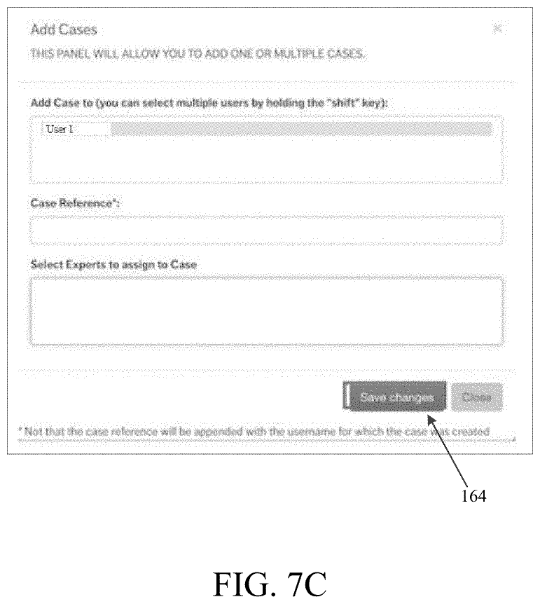

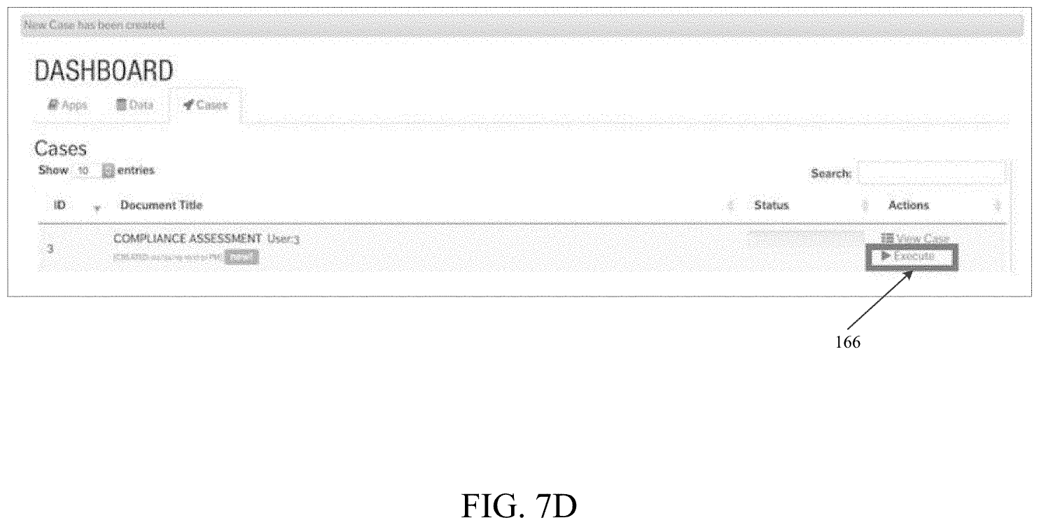

FIGS. 7A-7D are screenshots illustrating generation of the customized knowledge capture website, in connection with step 38 of FIG. 2. FIG. 7A is a screenshot of the library screen of the web interface modeling engine 24 after the web authoring document 72 has been compiled and enriched. Once the compiling process and the enrichment process are completed, and the application is ready to publish, as indicated by the compile indicator 134, the enrichment indicator 136, and the publish indicator 140, the user can select the user home button 160 to access the web application. FIG. 7B shows a home interface which is displayed after the user selects the home button 160. The home interface includes a “create case” button 162 that the user can select to proceed. FIG. 7C shows the next screen, where the user can add one or more cases, e.g., users that are assigned with viewing and completing the application. Selecting the “save changes” button 164 will progress the user to the dashboard, as seen in FIG. 7D, where the user can select the execute button 166 to execute the application created from the web authoring document 72.

As discussed above, the web interface modeling engine 24 processes the web authoring document 72, determines the custom label applied to each text portion of the web authoring document 72, and translates each custom label into a corresponding guided knowledge capture web page of the application. Each different custom label can correlate to a single guided knowledge capture web page/application comprising one or more of instructional information, notes/messages, and/or questions with interactive answer/choice buttons (e.g., a multiple choice button(s), a text entry box(es), a drop down list(s), a yes/no or true/false button(s), etc.), among other options. While using the application, the knowledge capture logic records user input (e.g., the selections made/answers provided on each guided knowledge capture web page/application) and advances the user to further guided knowledge capture web pages/applications based on the selections made/answers provided.

FIGS. 8A-8E are screenshots of the customized knowledge capture website (or, web application) in operation in connection with step 40 of FIG. 2. FIG. 8A shows the information from paragraph 78 of the web authoring document 72 (see FIG. 5C) displayed to the user in the “INFORMATION” label. Accordingly, in the application, the user is presented with an information page 170 that reads: “We are assessing at company level our team's knowledge and commitment to our Integrity and Compliance program. This App will help assess your level of understanding and accordingly recommend the action we think you should take—be it learning on your own or taking additional courses.”

Progressing to a next page of the application, FIG. 8B shows the note from sentence 82 of the web authoring document 72 (see FIG. 5D) displayed to the user in the “NOTE” label. Accordingly, in the application, the user is presented with a note page 172 that reads: “It should only take 5-15 minutes of your time.”

Progressing to a next page of the application, FIG. 8C shows the first question from multiple question text 86 of the web authoring document 72 (see FIG. 5E) displayed to the user in the “QUESTION” label. Accordingly, in the application, the user is presented with two questions 176, 178. The two questions 176, 178 request the user to enter their name and role within the company in input boxes 177 and 179, respectively.

Progressing to a next page of the application, FIG. 8D shows the second question from question 100 of the web authoring document 72 (see FIG. 5H) displayed to the user in the “QUESTION” label. Accordingly, in the application, the user is presented with a question 180 that reads: “Based on a quick glance at our policy document, how would you rate your understanding and commitment to our Integrity and compliance policy?” A set of answers 181 based on paragraphs 104, 108, and 110 is displayed for selection. Based on the user's answer, the application progresses to an appropriate next page, as shown in FIG. 8E. Specifically, FIG. 8E shows a task based on the user's reply to the question 100, as discussed above in FIG. 5H. Accordingly, in the application, the user is presented with a task 182 to read the policy document again.

As referenced in connection with FIG. 1, the web interface authoring platform can include the auto-styling module 25. The auto-styling module 25 can alleviate some of the need to apply custom labels to the text input in the web authoring document 16. Specifically, the auto-styling module can use a neural network(s) and/or a machine learning system to remove the need to manually label a document by predicting the type of paragraph, e.g., the label that should be applied to the paragraph, based on content and syntax of the paragraph itself. For example, the auto-styling module can automatically match the text of “(a) What is your name? (name)” with a question label.

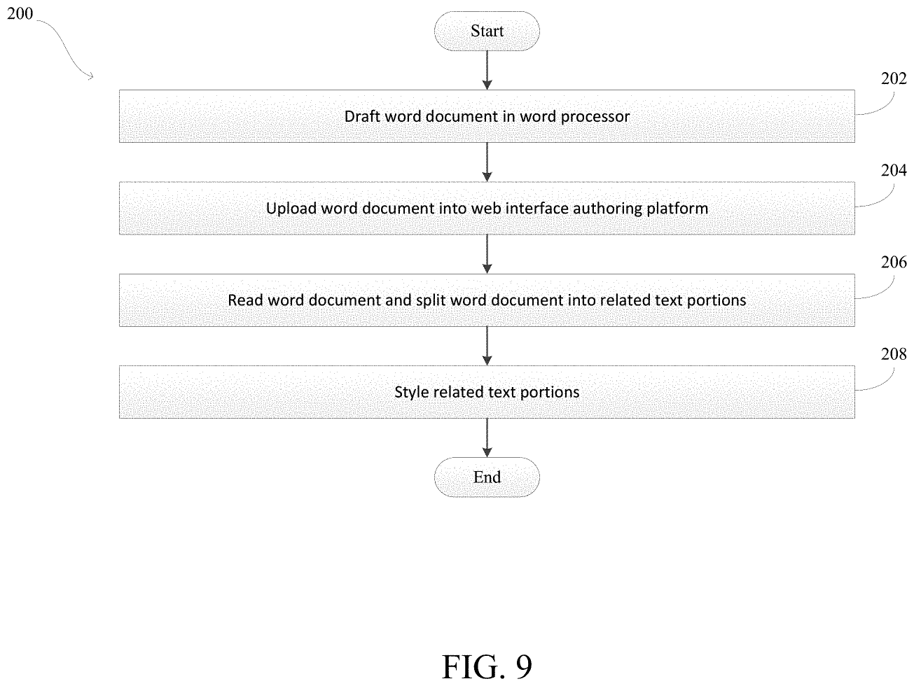

FIG. 9 is a flowchart illustrating the process steps being carried out by the system 10 for using the auto-styling module 25, indicated generally at method 200. In step 202, the user drafts a word document in the word processor 14 using standard syntax, e.g., syntax normally used for a non-auto-labeled document. In particular, the user need not apply labels to the document, as such can be done by the auto-styling module 25.

In step 204, a user uploads the word document into the web interface authoring platform 22, e.g., using the user device 12 and via the network 20. In step 206, the auto-styling module 25 reads the word document and splits the word document into related paragraphs. In step 208, the auto-styling module automatically labels the related paragraphs. For example, the auto-styling module 25 can use a neural network(s) and/or a machine learning system, such as but not limited to, a recurrent neural network (e.g., a long short-term memory (“LSTM”) network), a deep neural network (“DNN”), a Gaussian mixture model (“GMM”), a Hidden Markov model (“HMM”), or any other suitable system, to analyze each paragraph and determine which label should be applied thereto. The auto-styling module 25 can be trained based on documents compiled using the web interface modeling engine 24 as a dataset.

The auto-styling module 25 can be periodically re-trained from datasets, which can come from verified workflows. For example, data can be aggregated anonymously (independent of the document they come from) from use of the present system and pooled together into a re-training dataset. By using datasets from only the present system, it can be confirmed that the data used for re-training is correct and similar to the production data. The auto-styling module 25 can also be periodically re-tweaked and re-engineered to incorporate the most up-to-date-machine learning algorithms.

Additionally, the auto-styling module 25 can use the content of paragraphs in a word document to automatically generate appropriate syntax and predict workflow content based on logic and syntax constructions in previous documentation. For example, if most questions starting with “do you . . . ” have the answers “Yes” and “No,” then the auto-styling module 25 can predict that the answers to the next question starting with “do you . . . ” will be “Yes” and “No” and can generate a workflow accordingly. Furthermore, the auto-styling module 25 can identify whether a question deals with compliance, and if it does, automatically add a task for the user to complete in order to satisfy the compliance requirements if the user answers negatively to the question assessing non-compliance.

It should be understood that generating the “compliance assessment” web authoring document and corresponding application is used by way of example. The system 10 can be used to generate different types of applications relating to, for example, contracts, different document types, exams, manuals, etc.

In addition, although the foregoing description has been presented in connection with word processing tools to capture text and information, it is envisioned that the system can use other tools in addition to, or in place of, word processors for data input. For example, one or more speech capturing tools can be implemented which can allow a user to input data and label the data with customized labels using speech. In such instances, the speech capturing tools can record the spoken words of the user as text in a web authoring document, or, alternatively, the system can translate and convert the user's speech directly into a customized knowledge capture website without first converting the speech to text. For example, the web authoring document itself could be a sound recording as opposed to a word processing document. Thus, the term web authoring document should not be understood to be limited to a word processing document.

Additionally, the system can be extended to allow collaboration between multiple users. This can be, for example, at the level of knowledge capture or at the customized knowledge capture web site generated by the system.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A system for generating a customized knowledge capture website, comprising:
a memory; and
a processor in communication with the memory, the processor:
transmitting a web authoring document template to a user device,
receiving, from the user device, a completed web authoring document comprising the web authoring document and text input by a user,
compiling the completed web authoring document to generate at least one guided knowledge capture web page with embedded knowledge capture logic corresponding to the text, and
generating a customized knowledge capture website from the at least one guided knowledge capture web page,
wherein the customized knowledge capture website is accessible from the user device.

2. The system of claim 1, wherein the processor
utilizes a neural network or machine learning algorithm to
parse the completed web authoring document into a plurality of text portions based on content of the text comprising each text portion, and
determine a text type for each of the plurality of text portions based on a content of each text portion or metadata associated with the label of each text portion, and
apply a label to each parsed text portion.

3. The system of claim 1, wherein the web authoring document template is one of a blank word processing document, a template word processing document, or an imported word processing document.

4. The system of claim 1, wherein the web authoring document template (i) includes a plurality of label buttons, each of the plurality of label buttons being respective buttons having a label associated therewith that can change one or more of a font, a color, a size, a position, or a style of the text, and (ii) is configured to apply, based on user input, at least one label to text input into the web authoring document template via the plurality of label buttons and associate metadata with the text.

5. The system of claim 4, wherein the processor compiles the completed web authoring document by
parsing the text of the completed web authoring document into a plurality of text portions based on at least one of a content of the text or metadata associated with the text comprising each text portion,
determining a text type for each parsed text portion based on the metadata associated with each parsed text portion,
generating a workflow step for each determined text type, and
generating a workflow based on the generated workflow steps for each determined text type.

6. The system of claim 5, wherein the processor
determines the text type is a title or information and generates metadata to display a title or information workflow step,
determines the text type is a question and generates metadata to display a question workflow step and identifies at least one of an answer or a next workflow step associated with the question workflow step,
determines the text type is a result and identifies content and label information of the result to determine a next workflow step associated with the result and a condition for displaying a result of the result based on at least one previous workflow step associated with the result, or
determines the text type is a type other than the title, information, question and result and executes a function to generate a workflow step associated with the other type.

7. The system of claim 1, wherein
the guided knowledge capture website includes at least one of instructional information, a note, a message, or a question with interactive answer buttons including one of a multiple choice button, a text entry box, a drop down list, a yes or no button, and a true or false button, and
the embedded knowledge capture logic records a selection provided in response to the question via the interactive answer buttons.

8. The system of claim 1, wherein the web authoring document template is customizable by a speech-to-text module.

9. A system for generating a customized knowledge capture website, comprising:
a memory; and
a processor in communication with the memory, the processor:
generating a web authoring document template including embedded labels that are interpretable by the processor, the web authoring document template being customizable by a plurality of label buttons which are each configured to apply one of the embedded labels to text input into the web authoring document template and associate metadata with the text,
transmitting the web authoring document template to a user device,
receiving, from the user device, a completed web authoring document comprising the web authoring document and text having at least one of the embedded labels associated with the text,
compiling the completed web authoring document, including:
identifying each label applied to the text and the associated metadata, and
translating each label to generate at least one guided knowledge capture web page with embedded knowledge capture logic corresponding to the text and the embedded labels associated with the text, and
generating a customized knowledge capture website from the at least one guided knowledge capture web page,
wherein the customized knowledge capture website is accessible from the user device.

10. The system of claim 9, wherein the web authoring document template is one of a blank word processing document, a template word processing document, or an imported word processing document.

11. The system of claim 9, wherein the web authoring document template includes the plurality of label buttons, each of the plurality of label buttons being respective buttons having a label associated therewith that can change one or more of a font, a color, a size, a position, or a style of the text.

12. The system of claim 9, wherein the web authoring document template is customizable by a speech-to-text module.

13. The system of claim 9, wherein
the at least one guided knowledge capture website includes at least one of instructional information, a note, a message, or a question with interactive answer buttons including one of a multiple choice button, a text entry box, a drop down list, a yes or no button or a true or false button, and
the embedded knowledge capture logic records a selection provided in response to the question via the interactive answer buttons.

14. The system of claim 9, wherein the processor
parses the text of the completed web authoring document into a plurality of text portions based on metadata associated with the text comprising each text portion,
determines a text type for each parsed text portion based on the metadata associated with the parsed text portion,
generates a workflow step for each determined text type, and
generates a workflow based on the generated workflow steps for each determined text type.

15. The system of claim 14, wherein the processor
determines the text type is a title or information and generates metadata to display a title or information workflow step,
determines the text type is a question and generates metadata to display a question workflow step and identifies at least one of an answer or a next workflow step associated with the question workflow step,
determines the text type is a result and identifies content and label information of the result to determine a next workflow step associated with the result and a condition for displaying a result of the result based on at least one previous workflow step associated with the result, or
determines the text type is a type other than the title, information, question and result paragraphs and executes a function to generate a workflow step associated with the other type.

16. A method for generating a customized knowledge capture website comprising the steps of:
generating a web authoring document template including embedded labels that are interpretable by a processor, the web authoring document template being customizable by a plurality of label buttons which are each configured to apply one of the embedded labels to text input into the web authoring document template and associate metadata with the text,
transmitting the web authoring document template to a user device;
receiving, from the user device, a completed web authoring document comprising the web authoring document and text having at least one of the embedded labels associated with the text;
compiling the completed web authoring document, including:
identifying each label applied to the text and the associated metadata, and
translating each label to generate at least one guided knowledge capture web page with embedded knowledge capture logic corresponding to the text and the embedded labels associated with the text; and
generating a customized knowledge capture website from the at least one guided knowledge capture web page,
wherein the customized knowledge capture website is accessible from the user device.

17. The method of claim 16, wherein the web authoring document template is one of a blank word processing document, a template word processing document, or an imported word processing document.

18. The method of claim 16, wherein the web authoring document template includes the plurality of label buttons, each of the plurality of label buttons being respective buttons having a label associated therewith that can change one or more of a font, a color, a size, a position, or a style of the text.

19. The method of claim 16, further comprising the steps of
parsing the text of the web authoring document into a plurality of text portions based on metadata associated with the text comprising each text portion;
determining a text type for each parsed text portions based on the metadata associated with the parsed text portion;
generating a workflow step for each determined text type; and
generating a workflow based on the generated workflow steps for each determined text type.

20. The method of claim 19, further comprising at least one of the following steps:
determining the text type is a title or information and generates metadata to display a title or information workflow step;
determining the text type is a question and generates metadata to display a question workflow step and identifies at least one of an answer or a next workflow step associated with the question workflow step;
determining the text type is a result paragraph and identifies content and label information of the result to determine a next workflow step associated with the result and a condition for displaying a result of the result based on at least one previous workflow step associated with the result; and
determining the text type is a type other than the title, information, question and result paragraphs and executes a function to generate a workflow step associated with the other type.
